(19) United States
(12) Patent Application Publication
(10) Pub. No.: US 2026/0334550 A1
(43) Pub. Date: Oct. 29, 2026

(54) Aerosol Generating Device with a Vacuum Insulator

(71) Applicant: JT International SA, Geneva (CH)

(72) Inventor: Eduardo Jose Garcia Garcia, Grand-Saconnex (CH)

(73) Assignee: JT International SA, Geneva (CH)

(21) Appl. No.: 19/106,349

(22) PCT Filed: Aug. 24, 2023
(86) PCT No.: PCT/EP2023/073308

§ 371 Date: Feb. 25, 2025

(30) Foreign Application Priority Data
Sep. 1, 2022 (EP) 22193484.7

(51) Int. Cl. A24F 40/46; H05B 3/00

(52) U.S. Cl. CPC A24F 40/46; H05B 3/0014

(57) ABSTRACT

An aerosol generating device includes: a vacuum insulator including an inner wall and an outer wall between which vacuum is enclosed; a cavity in which an aerosol forming substance can be received, positioned adjacent the inner wall of the vacuum insulator and having an opening to enable a user to insert the aerosol forming substance into the cavity; a heater provided in thermal contact with the inner wall, configured to heat an aerosol forming substance received in the cavity by thermal conduction to generate an aerosol; and a thermal bridge provided between the inner wall and the outer wall to allow a path for heat to be conducted, wherein the thermal bridge is positioned in the vacuum between a first end of the vacuum insulator that is closest to the opening and the heater to enable the transfer of heat from the inner wall to the outer wall by conduction.

### FIELD OF INVENTION

The invention relates to aerosol generating devices. In particular, the invention relates to aerosol generating devices with a vacuum insulator.

### BACKGROUND

Aerosol generating devices can include a heater and a vacuum insulator to insulate the heater from the external environment. Heat can be lost from an opening of the vacuum insulator, reducing the thermal efficiency of the device and presenting a potential safety risk to the user if the opening reaches sufficiently high temperatures. There is therefore a demand for safer and more efficient aerosol generating devices. There is also a demand for solutions compatible with existing designs of aerosol generating devices, as well as for more convenient and compact aerosol generating devices.

It is an object of the present invention to address these demands.

### SUMMARY OF INVENTION

According to an aspect of the invention there is provided an aerosol generating device configured to generate an aerosol for inhalation by a user, comprising: a vacuum insulator, comprising an inner wall and an outer wall between which a vacuum is enclosed; a cavity in which an aerosol forming substance can be received, positioned adjacent the inner wall of the vacuum insulator and having an opening to enable a user to insert the aerosol forming substance into the cavity; a heater provided in thermal contact with the inner wall, configured to heat an aerosol forming substance received in the cavity by thermal conduction to generate an aerosol; and a thermal bridge provided between the inner wall and the outer wall to allow a path for heat to be conducted, wherein the thermal bridge is positioned in the vacuum between a first end of the vacuum insulator that is closest to the opening and the heater to enable the transfer of heat from the inner wall to the outer wall by conduction.

In aerosol generating devices with a vacuum insulator, a significant amount of heat from the heater can flow along the inner wall towards the opening, into which a consumable can be inserted. This can cause the end of the vacuum insulator that is closest to the opening to reach high temperatures. It has been found that this enables a heat to leak from the aerosol generating device. The present invention employs a thermal bridge between the inner and outer walls of the vacuum insulator provided in the vacuum between the heater and the first end. In this way, heat can flow along the inner wall to the outer wall using the thermal bridge, allowing some of the heat to flow away from the first end. This can reduce the maximum operating temperature of the first end in use, thereby improving the efficiency of the device. This can also improve the safety of the device by reducing the temperature of components that the user could touch accidentally. Providing a thermal bridge inside the vacuum insulator also beneficially avoids changing the external shape or dimensions of the vacuum insulator, enabling the solution of the present invention to be compatible with existing designs of aerosol generating devices.

The thermal bridge is provided “in the vacuum”, i.e. inside the vacuum insulator between the inner and outer walls that enclose the vacuum. The thermal bridge may be fully or substantially surrounded by the vacuum.

The thermal bridge may comprise any suitable connecting structure that enables heat to flow from the inner wall to the outer wall. In one example, the thermal bridge may comprise one or more rigid struts or ribs. In another example, the thermal bridge may comprise one or more heat conducting wires.

Preferably, the thermal bridge is positioned on the inner wall longitudinally between the heater and the first end of the vacuum insulator. In other words, the thermal bridge is provided at a circumferential position on the inner wall that is approximately “above” the heater, or in line with the heater, towards the first end. In this way, the thermal bridge can be positioned close to or along the most direct path along the inner wall from the heater to the first end, enabling a more effective redirection of heat towards the outer wall. In other embodiments, the thermal bridge could be provided at other circumferential positions on the inner wall.

Preferably, the thermal bridge is provided on the inner wall at a position that is spaced by 1 mm or more from the heater towards the first end. In this way, the thermal bridge can avoid allowing too much heat to flow to the outer wall, which could reduce the thermal efficiency of the device. The thermal bridge may be spaced by 1 mm, 1.5 mm, 2 mm, 5 mm, or any other suitable distance from the heater.

Preferably, the position of the thermal bridge on the inner wall is selected to maintain an external surface of the aerosol generating device adjacent the first end of the vacuum insulator at or below 48 °C while the heater is in use. In this way, the external surface of the aerosol generating device adjacent the first end can be maintained at temperatures that are safe and thermally efficient. The external surface can be a housing or outer casing configured to contain and protect components of the aerosol generating device. The thermal bridge may be positioned based on testing of different spacings from the heater while the heater is turned on and in use. The specific positioning on the inner wall may be dependent on the particular design and operating parameters of the aerosol generating device. The skilled person would appreciate that the positioning, length, thickness, material, and/or structure of the thermal bridge may be adjusted in various ways to maintain a temperature of 48 °C while the heater is in use.

Preferably, the heater is provided in the vacuum on the inner wall. In this way, the heater can be insulated from the external environment more effectively. Alternatively, the heater could be provided on the inner wall outside of the vacuum (e.g. on the inner surface of the inner wall).

Preferably, the thermal bridge comprises a metal such as stainless steel. In other embodiments, the thermal bridge could comprise any other suitable thermally conductive material, such as copper or ceramic.

Preferably, the thermal bridge provides structural support to the inner wall and the outer wall. Thus, the thermal bridge may comprise a rigid structure. In this way, the vacuum insulator can be made more robust. This extra robustness can enable the inner and outer walls to be made thinner, which has been shown to improve heating efficiency and the speed at which the aerosol generating substance reaches optimum temperatures. Thinner inner and outer walls also enables the vacuum insulator to be more compact, which improves the convenience of the device for the user.

In some embodiments, the thermal bridge comprises one or more ribs provided at circumferentially spaced positions on the inner wall. For example, the thermal bridge can comprise two, three, four or more ribs or struts spaced evenly or irregularly around the inner wall.

In some embodiments, the thermal bridge is configured to separate a first part of the vacuum from a second part of the vacuum. For example, the thermal bridge may comprise a surface positioned with a vacuum adjacent both faces of the surface so that the surface isolates two portions of the vacuum from one another completely. In this way, the thermal isolation of the first end can be improved. The thermal bridge can comprise an annular connecting surface, in one example.

Preferably, the aerosol generating device further comprises a plurality of heaters and a plurality of thermal bridges, wherein each thermal bridge is positioned longitudinally between a respective heater and the first end of the vacuum insulator. In this way, more even heating of the aerosol forming substance can be achieved while reducing the maximum temperature of the first end in use using the plurality of thermal bridges.

Preferably, the vacuum insulator comprises a closed second end opposite the first end. The closed second end may be more effective at insulating the remaining components of the aerosol generating device from the heater compared to the open first end. Providing the thermal bridge between the first end and the heater in this case positions the thermal bridge most effectively. In one example, the inner wall and the outer wall may each have a substantially U-shaped cross section that are joined together only at the first end.

In other embodiments, the first end and the second end may both be open, so that the vacuum insulator is substantially tube shaped.

### BRIEF DESCRIPTION OF DRAWINGS

Embodiments of the invention are now described, by way of example, with reference to the drawings, in which:

FIG. 1 is a cross-sectional schematic diagram of an aerosol generating device in an embodiment of the invention;

FIG. 2 is a plan view of a vacuum insulator in an embodiment of the invention; FIG. 3 is a cross-sectional schematic diagram of a portion of a vacuum insulator in an embodiment of the invention; and FIG. 4 is a schematic diagram of a portion of a vacuum insulator in an embodiment of the invention.

### DETAILED DESCRIPTION

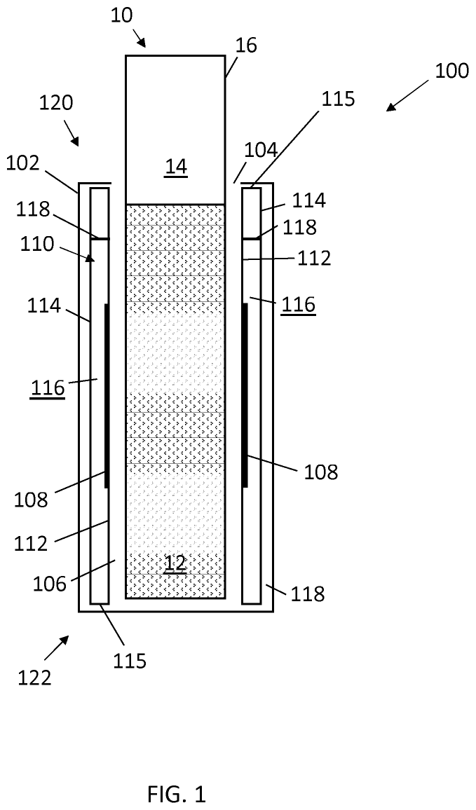

FIG. 1 is a cross-sectional schematic diagram of an aerosol generating device in an embodiment of the invention. An aerosol generating device 100 is provided and comprises an outer casing 102 for housing internal components of the aerosol generating device 100. The outer casing 102 comprises an opening 104 to a cavity 106 configured to receive a consumable 10. The consumable 10 comprises tobacco 12 and a filter 14, both of which may be held together by a tipping wrapper 16. A vacuum insulator 110 is provided and has an annular cylindrical shape with an inner wall 112 and an outer wall 114, between which a vacuum 116 is enclosed. A heater 108 is provided in the vacuum 116 on an outer surface of the inner wall 114 and is configured to provide heating to the consumable 10 when received within the cavity 106 to generate an aerosol. A thermal bridge 118 is provided in the vacuum 116 between the heater 108 and a first end 120 of the vacuum insulator 110 that is closest to the opening 104. The thermal bridge 118 provides a path for heat to flow from the inner wall 112 to the outer wall 114 to reduce the temperature of the first end 120 of the vacuum insulator 110 in use.

The aerosol generating device 100 also comprises a controller (not shown) for controlling operations of the aerosol generating device 100, a button (not shown) for receiving instructions from a user, an air inlet (not shown) in fluid communication with the cavity 106, and a battery (not shown) to power the aerosol generating device 100. The controller and battery are in electric communication with the button and heater 108 via wires (not shown).

The outer casing 102 may comprise any suitable material as is known in the art, such as metal or plastic. As shown in FIG. 1, the aerosol generating device 100, the vacuum insulator 110, and the cavity 106 can be elongate along a longitudinal direction.

In the embodiment of FIG. 1, the heater 108 is provided inside the vacuum 116 at two separate positions on circumferentially opposing portions of the inner wall 112. The heater 108 comprises two resistive film heaters configured to generate heat when provided with an electric current. The film heaters are curved to match the curvature of the inner wall 112 to enable good thermal contact with the inner wall 112. In alternative embodiments, the heater 108 may be provided as any suitable heater that can heat the consumable 10 within the cavity 106 to generate an aerosol. In other examples, the heater 108 may be provided outside of the vacuum 116 such as at a periphery of the cavity 106. The heater 108 can be provided as one or more curved heating films or tracks that extend around the circumference of the inner wall 112. Alternatively, the heater 108 may be provided as one or more heating films or tracks provided at spaced positions around the inner wall.

The heater 108 is configured to heat the inner wall 112 by conduction to raise the temperature of air in the cavity 106 to aerosol generating temperatures. The consumable 10 may have a circumference substantially matching the circumference of the cavity 106 so that the consumable 10 is in contact with the inner wall 112 when it is placed into the cavity 106 by a user. The heater 108 heats the contents of the cavity 106 to a temperature sufficient to generate an aerosol using the tobacco 12 inside the consumable 10. The heater 108 may be configured to heat the contents of the cavity 106 to temperatures below the combustion temperature of the tobacco 12, enabling the aerosol generating device 100 to function as a so-called “heat-not-burn” aerosol generating device. In other embodiments, the cavity 106 and the heater 108 may be configured to receive and heat, respectively, other forms of consumables as is known in the art. For example, the cavity 106 may be configured to receive a consumable cartridge comprising a reservoir containing an aerosol generating fluid, and the heater 108 may be configured to provide heating to the consumable when received in the cavity 106. In such cases, the vacuum insulator 110 and cavity 106 may be shaped appropriately so that the cartridge can be received within the cavity 106 to be heated by the heater 108 and insulated by the vacuum insulator 110.

The vacuum insulator 110 of FIG. 1 has an annularly cylindrical shape with a circular cross-section. The vacuum insulator 110 is hollow and encloses a vacuum 116 between a curved inner wall 112, a curved outer wall 114, and two flat surfaces 115 that connect the inner wall 112 and the inner wall 114. In other embodiments, the vacuum insulator 110 may have other shapes. For example, the vacuum insulator 110 may have a square or polygonal cross-section, or any other suitable cross-sectional shape. The vacuum insulator 110 of FIG. 1 has a tubular shape with two open ends; however, the vacuum insulator 110 may also have a cup-shaped cross section with only one open end. In another example, the outer wall 114 may be joined directly to the inner wall 112 without a connecting flat surface 115 at a first end 120 of the vacuum insulator 110, as shown in FIG. 3. The vacuum insulator 110 may be mechanically attached to the outer casing 102 by one or more mechanical couplings (not shown). The vacuum insulator 110 may comprise stainless steel, heat resistant plastic such as PEEK, or any other suitable materials.

The controller may be housed within the outer casing 102 and comprises a memory and a processor for storing and executing instructions to control various operations of the aerosol generating device 100. The air inlet may be provided as an opening in the outer casing 102 towards a second end 122 of the aerosol generating device 100 to enable the user to draw air through the cavity 106 via the filter 14. The button may also be provided on an external surface of the outer casing 102 for receiving an input from the user. Alternatively, any other input mechanism, such as a fingerprint or airflow sensor, may be provided for receiving an input from the user.

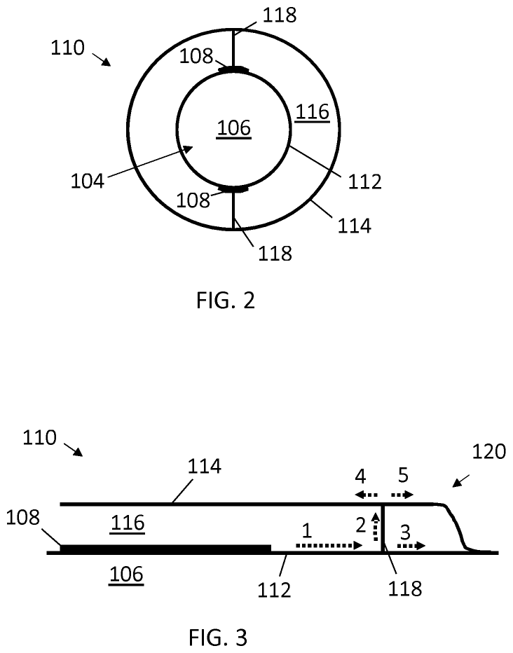

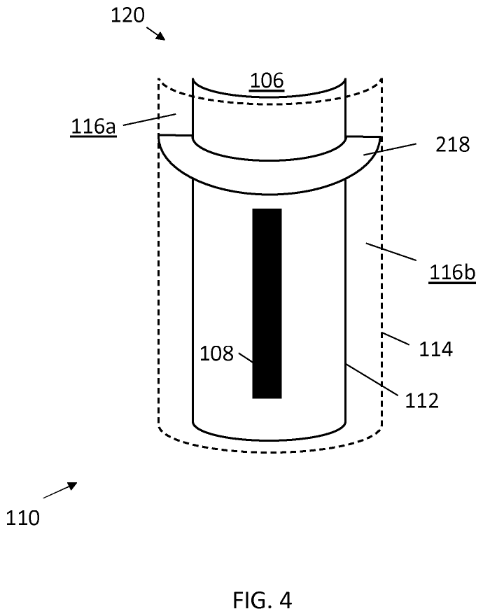

In the embodiment of FIGS. 1 to 3, the thermal bridge 118 comprises two straight and rigid ribs or struts connecting the inner and outer walls 112, 114, each positioned directly between a respective heating plate of the heater 108 and the first end 120 of the vacuum insulator 110. A plan view of the vacuum insulator 110 from above the first end 120 is shown in FIG. 2, showing the two ribs having opposing circumferential positions on the inner wall 112. In other embodiments, the ribs can be positioned at other circumferential positions on the inner wall 112. The rigidity of the ribs can provide structural support to the inner and outer walls 112, 114.

The thermal bridge 118 may comprise any suitable material for enabling heat to flow from the inner wall 112 to the outer wall 114, such as stainless steel, copper, other metals, or non-metallic materials. Additional or fewer ribs may be provided in other embodiments of the invention. The ribs or struts may be placed at equally spaced or irregular positions on the inner wall 112. The thermal bridge 118 could also comprise other types of structure suitable for enabling a flow of heat by conduction from the inner wall 112 to the outer wall 114.

An example use of the aerosol generating device 100 will now be described with reference to FIG. 1. In use, a user can insert the consumable 10 through the opening 104 into the cavity 106. The inner wall 112 holds the consumable 10 in place within the cavity 106 by friction. This contact between inner wall 112 and the consumable 10 also increases the efficiency with which heat is delivered to the tobacco 12 within the consumable 10. When the user is ready to initiate vaporisation, the user may press the button, which in turn triggers the controller to turn on the heater 108. The heater 108 provides heating to the contents of the cavity 106, including the consumable 10, while the vacuum 116 within the vacuum insulator 110 inhibits the escape of heat from the cavity 106 by conduction and convection. Thus, the cavity 106, the heater 108, and the vacuum insulator 110 form an oven in which the tobacco 12 within the consumable 10 can be heated to a desired temperature. The controller may be configured to instruct the heater 108 to heat the tobacco 12 to temperatures below the combustion temperature of tobacco. As the tobacco 12 is heated, an aerosol is produced inside the cavity 106. The user can inhale the aerosol by drawing air through the air inlet via the filter 14 to generate an airflow through the cavity 106 which carries the aerosol to the user.

It has been found that in similar known aerosol generating devices the end of the vacuum insulator nearest the opening to the cavity can reach undesirably high temperatures during use of the aerosol generating device. Said end has contact with the air in the cavity, which is heated by the hot walls of the vacuum insulator. The heated air can be carried out of the cavity by airflow caused by the user or air passing over the opening. This can carry heat out of the cavity, thereby reducing the efficiency of the aerosol generating device. The high temperature of the exposed end of the vacuum insulator can also heat an external surface of the outer casing 102 to high temperatures, which may present a safety risk.

The aerosol generating device 100 of the present invention utilises the thermal bridge 118 to mitigate these issues. FIG. 3 shows a schematic diagram of part of a cross section of the vacuum insulator 110 while the heater 108 is in operation. FIG. 3 shows schematic arrows 1-5 indicating the flow of heat by conduction in the vacuum insulator 110. While the heater 108 is turned on, a first portion of heat 1 flows from the heater 108 along the inner wall 112 towards the first end 120. A second portion of heat 2, which is a proportion of the first portion 1, flows along the thermal bridge 118 to the outer wall 114. A remaining proportion 3 of the first portion 1 flows towards the first end 120. The second portion 2 reaches the outer wall 114 and diffuses across the surface of the outer wall 114, spreading out in different directions as at least fourth and fifth portions of heat 4, 5. As shown, at least the fourth portion 4 is diverted away from the first end 120, thereby reducing the operating temperature of the first end 120 of the vacuum insulator 110 during use.

For the fifth portion of heat 5, the conductive path length from the heater 108 to the first end 120 of the vacuum insulator 110 is increased by the thermal bridge 118. Increasing the conductive path length provides more time for heat to be carried away from the first end 120 by radiation or other processes. Increasing the path length of heat to the first end 120 therefore reduces the amount of heat reaching the first end 120 by conduction.

The temperature of the inner wall 112 increases closer to the heater 108 during use. As the second portion 2 is a proportion of the first portion 1, the thermal bridge 118 can therefore divert more or less heat to the outer wall 114 depending on its proximity to the heater 108. It has been found that having a spacing of 1 mm or more from the heater 108 towards the first end 120 advantageously avoids overheating the outer wall 114. The amount of heat diverted from the first end 120 will, in general, depend on the materials and geometry of the vacuum insulator 110 as well as other factors such as the operating temperature of the heater 108. A range of spacings can be tested for a specific embodiment to determine the necessary spacing of the thermal bridge 118 from the heater 108 to maintain a temperature of an external surface of the vacuum insulator 110 adjacent the first end 120 of equal to or less than 48 °C. This can be advantageous for both safety and efficiency. The cross-sectional area in a longitudinal direction or a length of the thermal bridge 118 could also be varied in order to maintain this maximum temperature.

FIG. 4 is a schematic diagram of part of the vacuum insulator 110 in an alternative embodiment of the invention. The dashed line shows the position of the outer wall 114 which has been removed from the view so that the inner wall 112 and a thermal bridge 218 can be viewed. In the embodiment of FIG. 4, the thermal bridge 218 is provided as an annular ring that can also provide structural support to the inner wall 112 and the outer wall 114. The thermal bridge 218 separates the vacuum 116 into a first portion 116a and a second portion 116b, which can improve the thermal isolation of the first end 120. The thermal bridge 218 may be configured to divert a greater amount of heat to the outer wall 114 compared to the thermal bridge 118 due to the larger cross-sectional area (taken in a longitudinal direction) of the thermal bridge 218.

In other embodiments, the thermal bridge 218 may have any other suitable shape and may or may not partition the vacuum 116 into different isolated portions. For example, the thermal bridge 118 could be provided as a plurality of annular arcs at spaced positions around the circumference of the inner wall 112.

1. An aerosol generating device configured to generate an aerosol for inhalation by a user, comprising:
a vacuum insulator comprising an inner wall and an outer wall between which vacuum is enclosed;
a cavity configured to receive an aerosol forming substance therewithin, positioned adjacent the inner wall of the vacuum insulator, and having an opening to enable a user to insert the aerosol forming substance into the cavity;
a heater disposed in thermal contact with the inner wall, and configured to heat an aerosol forming substance received in the cavity by thermal conduction to generate an aerosol; and
a thermal bridge disposed between the inner wall and the outer wall to allow a path for heat to be conducted, wherein the thermal bridge is positioned in the vacuum between a first end of the vacuum insulator that is closest to the opening and the heater to enable the transfer of heat from the inner wall to the outer wall by conduction;
wherein the thermal bridge is positioned on the inner wall longitudinally between the heater and the first end of the vacuum insulator.

2. The aerosol generating device of claim 1, wherein the thermal bridge is disposed on the inner wall at a position that is spaced by 1 mm or more from the heater towards the first end.

3. The aerosol generating device of claim 2, wherein the position of the thermal bridge on the inner wall is configured to maintain an external surface of the aerosol generating device adjacent the first end of the vacuum insulator at or below 48 °C while the heater is in use.

4. The aerosol generating device of claim 1, wherein the heater is disposed in the vacuum on the inner wall.

5. The aerosol generating device of claim 1, wherein the thermal bridge comprises a metal.

6. The aerosol generating device of claim 1, wherein the thermal bridge provides structural support to the inner wall and the outer wall.

7. The aerosol generating device of claim 1, wherein the thermal bridge comprises one or more ribs disposed at circumferentially spaced positions on the inner wall.

8. The aerosol generating device of claim 1, wherein the thermal bridge is configured to separate a first part of the vacuum from a second part of the vacuum.

9. The aerosol generating device of claim 1, wherein the heater comprises a plurality of heaters and the thermal bridge comprises a plurality of thermal bridges, wherein each thermal bridge is positioned longitudinally between a respective heater and the first end of the vacuum insulator.

10. The aerosol generating device of claim 1, wherein the vacuum insulator comprises a closed second end opposite the first end.

11. The aerosol generating device according to claim 1, wherein the thermal bridge comprises stainless steel.
